(19) United States
(12) Patent Application Publication
(10) Pub. No.: US 2004/0046508 A1
(43) Pub. Date: Mar. 11, 2004

(54) Vehicle head lamp apparatus

(76) Inventor: Tetsuya Ishida, Shizuoka (JP)

Correspondence Address: FISH & RICHARDSON P.C., 45 ROCKEFELLER PLAZA, SUITE 2800, NEW YORK, NY, 10111, US

(21) Appl. No.: 10/652,395

(22) Filed: Aug. 29, 2003

(30) Foreign Application Priority Data
Sep. 10, 2002 (JP) P. 2002-263599

(51) Int. Cl. B60Q 1/00

(52) U.S. Cl. 315/77; 315/82

(57) ABSTRACT

A head lamp device includes: a swivel lamp 3R, 3L having a projector lamp 30 capable of controlling an irradiating direction or an irradiating range of light emitted from a light source 17; an actuator 4 including a brushless motor and a gear mechanism for deflecting the projector lamp 30; a Hall element for detecting a rotary range of the brushless motor; and an abnormality judgment means for judging an abnormality of the actuator 4 according to a rotary range of the brushless motor detected by the Hall element when the brushless motor is driven according to a predetermined condition. A cause of the abnormality of the actuator 4 can be properly judged without using a potentiometer, and AFS can be properly controlled.

### BACKGROUND OF THE INVENTION

The present invention relates to a head lamp device used for a vehicle such as an automobile. More particularly, the present invention relates to a vehicle head lamp apparatus capable of judging an abnormality of a drive means for driving a light distribution means of the head lamp device, wherein the light distribution means changes an irradiation direction and an irradiation range of the head lamp according to a state of running of the vehicle. For example, the present invention relates to a vehicle head lamp apparatus having the Adaptive Front-lighting System which will be referred to as AFS, hereinafter.

As shown in the conceptional view of FIG. 1, in AFS which is proposed to enhance the safety property of driving an automobile, information expressing a state of running of an automobile CAR is detected by the sensor 1, and the thus obtained detection output is outputted into the electronic control unit 2 which will be referred to as ECU (Electronic Control Unit, hereinafter. For example, this sensor 1 includes: a steering angle sensor 1A for detecting a steering angle of steering wheel SW of automobile CAR; a vehicle speed sensor 1B for detecting a vehicle speed of automobile CAR; and vehicle level sensors (Only the vehicle level sensor 1C of the rear axle is shown in the drawing.) for detecting levels of the front and rear axles so as to detect a level of an automobile CAR. These sensors 1A, 1B, 1C are connected with ECU described before. According to the output of each sensor 1, which has been inputted into ECU 2, the swivel lamps 3R, 3L, which are respectively provided in the head lamps 3 arranged at the right and the left front portion of the automobile, are controlled being deflected to the right and left, that is, the swivel lamps 3R, 3L are controlled being deflected to the right and left so that the light distribution characteristic can be changed. As an example of the swivel lamp 3R, 3L, there is provided a head lamp having a rotation drive means for rotating a reflector or a projector lamp, which is arranged in the head lamp, in the horizontal direction by a drive power source such as a drive motor. A mechanism including this rotation drive means is referred to as an actuator in this specification. When this type AFS is adopted, while an automobile is running on a curved road, it is possible to illuminate a far side of the curved road corresponding to the running speed of the automobile. Therefore, the safety property of running can be enhanced.

In order to realize an appropriate illumination in this AFS, it is necessary for the steering angle of steering wheel SW to properly correspond to the deflection angle of the swivel lamp 3R, 3L. When the steering angle of steering wheel SW does not properly correspond to the deflection angle of the swivel lamp 3R, 3L, the optical axis of the swivel lamp 3R, 3L is directed to an undesirable direction with respect to the running direction of the automobile, for example, the head lamp can not illuminate the forward portion of the road when the automobile is running straight or the automobile is running on a curved road. Alternatively, the head light is deflected onto the opposed lane side, so that an opposed automobile is dazzled by the light from the head lamp, which causes problems from the viewpoint of safety of running.

In order to avoid the occurrence of the above problems, in the conventional AFS, there is provided a deflection angle detector for detecting a deflection angle of the actuator of the swivel lamp. For example, a potentiometer is arranged in an output shaft of the rotation drive means for driving the swivel lamp, and a rotation angle of the output shaft is detected from the output of the potentiometer, that is, the deflection angle is detected. However, when the above potentiometer is arranged, the structure of the actuator becomes complicated and further the size of the actuator is increased, that is, provision of the above potentiometer is not preferable. In order to solve the above problems, it is considered to detect a deflection angle of the swivel lamp by detecting a rotary angle of the drive motor which is a drive source to drive the rotation drive means for driving the actuator. As the rotary angle detector used for the object, a Hall element is used which outputs the number of pulses according to the rotation of the drive motor. That is, when pulse signals emitted from the Hall element according to the rotational motion of the drive motor are counted, the deflection angle of the actuator is indirectly detected, so that AFS can be appropriately controlled.

In the case of AFS described above, it is possible to appropriately control AFS according to the counted values of the pulse signals sent from the Hall element. However, in the case where the drive motor of the rotation drive means or the gear mechanism develops trouble, the counted values of the pulse signals of the Hall element do not correspond to the deflection angle of the swivel lamp. Therefore, AFS can not be properly controlled. Accordingly, it is necessary to monitor the rotation drive means at all times. Examples of trouble of the rotation drive means are: the drive motor is locked and can not be rotated at all; some gears are damaged in the gear mechanism for reducing the speed and transmitting the torque of the drive motor, and it becomes impossible to obtain a normal reduction ratio by the gear mechanism; and gears meshing with each other in the gear mechanism are seized to each other, and it becomes impossible for the drive motor and the gear mechanism to be normally rotated. In either case described above, the counted values of the pulse signals of the Hall element and the deflection angle of the swivel lamp do not correspond to each other. Accordingly, it is impossible to obtain a normal AFS motion.

In this case, as described above, when the counted values of the pulse signals of the Hall element are monitored, it possible to judge the occurrence of an abnormality of the rotational state of the drive motor, however, the following problems may be encountered. Even when the drive motor is normally operated, if the gear mechanism develops trouble, the rotation drive means can not be properly operated, and at the same time the rotation of the drive motor is affected. Therefore, when the occurrence of an abnormality is judges according to the counted values of the pulse signals, it is impossible to judge whether the abnormality of the rotation drive means is caused by the motor or the abnormality of the rotation drive means is caused by the gear mechanism which is arranged after the drive motor. As a result, an appropriate maintenance work for recovering AFS, which has developed trouble, can not be executed, that is, AFS can not be properly controlled. In this connection, the official gazette of JP-A-64-74137 discloses the following technique. In a cornering lamp system for vehicle use, when an irradiating direction of the head lamp means exceeds the maximum angular position, electric power supply to an electric motor to drive the head lamp means is stopped under the condition that electric power supply to the inverse direction of the electric motor can be conducted, so that the occurrence of burning trouble caused by motor lock can be prevented. The official gazette of JP-A-62-244220 discloses the following technique. In a cornering lamp system, when the supply of a starting signal to a step drive type motor to control an irradiating direction of the head lamp means is stopped after a predetermined period of time has passed, trouble of burning of the motor can be prevented. However, in the former prior art, the irradiating direction is detected by a different means from the motor. Therefore, it is difficult to detect trouble in the system only by the occurrence of an abnormality of in the motor. The latter prior art is effective to previously prevent the occurrence of trouble of burning of the motor. However, it is difficult to detect the occurrence of an abnormality in the system. Accordingly, even if the above prior arts are applied to AFS, it is difficult to conduct a proper maintenance work to solve the problems caused in AFS. Therefore, even if the above prior arts are applied to AFS, it is difficult to solve the problems described before in the present application.

SUMMARY OF THE INVENTION

It is an object of the present invention to provide a vehicle head lamp apparatus in which AFS can be properly controlled when a cause of trouble in an actuator rotation drive means in AFS is properly judged.

The present invention provides a vehicle head lamp apparatus comprising: a light distribution control means for controlling an irradiation direction or an irradiation range of light sent from a light source; a rotation drive means having a drive motor for driving the light distribution control means; a rotation range detection means for detecting a rotation range of the drive motor; and an abnormality judgment means for judging an abnormality of the rotation drive means according to a rotation range of the drive motor detected by the rotation range detection means when the rotation drive means is driven under a predetermined condition.

In this case, the abnormality judgment means judges an abnormality under the predetermined condition by comparing a rotation range, which is obtained when the drive motor is rotated in one direction and then rotated in the opposite direction, with a predetermined rotation range. Alternatively, the abnormality judgment means judges an abnormality under the predetermined condition by comparing one of the rotation ranges, one range is obtained when the drive motor is rotated in one direction and the other rotation range is obtained when the drive motor is rotated in the opposite direction, with a predetermined rotation range which is previously set, and when the rotation range is larger than the predetermined rotation range which is previously set, the rotation is judged to be abnormal. It is preferable that the abnormal judgment means repeats a judgment motion when it has judged an abnormality.

The head lamp device of the present invention includes: a rotation range detection means for detecting a rotation range of a drive motor of a rotation drive means for driving a light distribution control means of a head lamp; and an abnormality judgment means for judging an abnormality of the rotation drive means according to a rotation range of the drive motor detected by the rotation range detection means when the rotation drive means is driven under a predetermined condition. Therefore, it is possible to judge the occurrence of an abnormality when the drive motor or the gear mechanism composing the rotation drive means develops trouble. Further, it is possible to judge a specific cause of the trouble. Therefore, in the case of an abnormality of AFS, fail-safe operation can be realized. Accordingly, an automobile can be safely driven and a proper maintenance work can be executed even when an abnormality is caused. Further, it is possible to properly control AFS.

### BRIEF DESCRIPTION OF THE DRAWINGS

FIG. 1 is a view showing a conceptional arrangement of AFS;

FIG. 2 is a longitudinal sectional view showing a swivel lamp;

FIG. 3 is an exploded perspective view showing a primary portion of the internal structure of a swivel lamp;

FIG. 4 is an exploded perspective view showing a portion of an actuator;

FIG. 5 is a plan view showing an arrangement of an actuator;

FIG. 6 is a longitudinal sectional view showing an actuator;

FIG. 7 is a partially enlarged perspective view showing a brushless motor;

FIG. 8 is a block diagram showing a circuit structure of AFS;

FIG. 9 is a circuit diagram showing a circuit structure of an actuator;

FIG. 10 is a flow chart for detecting an abnormality of an actuator when an ignition switch is turned on;

FIG. 11 is a schematic illustration showing a relation between a counted value of an up and down counter and a rotation range value; and

FIG. 12 is a flow chart of another embodiment for detecting an abnormality of an actuator.

### DETAILED DESCRIPTION OF THE PREFERRED EMBODIMENTS

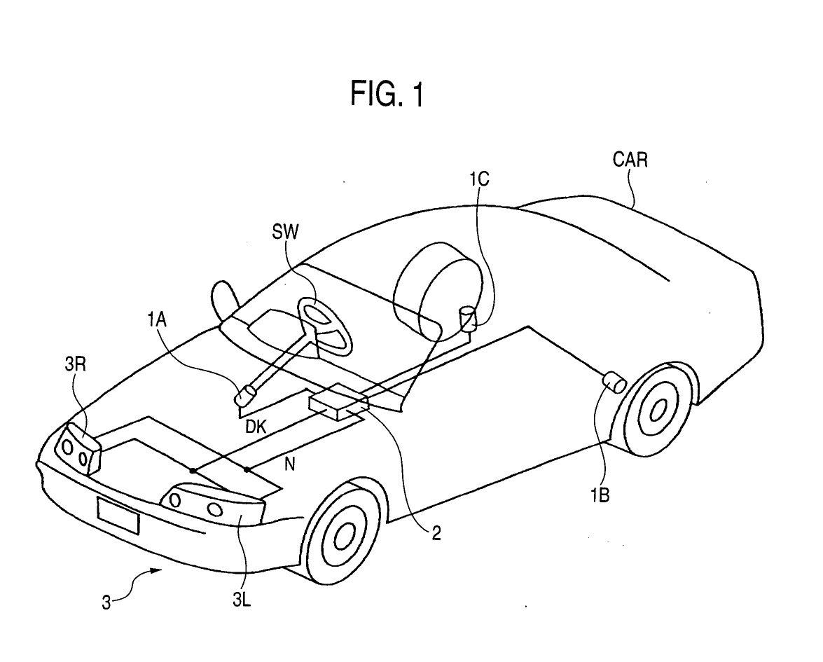

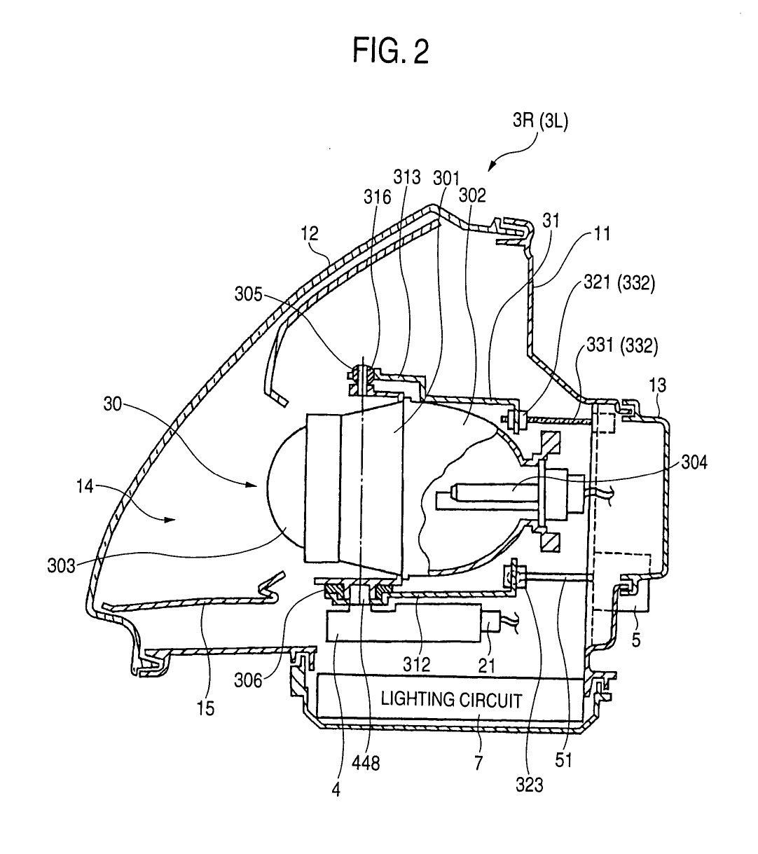

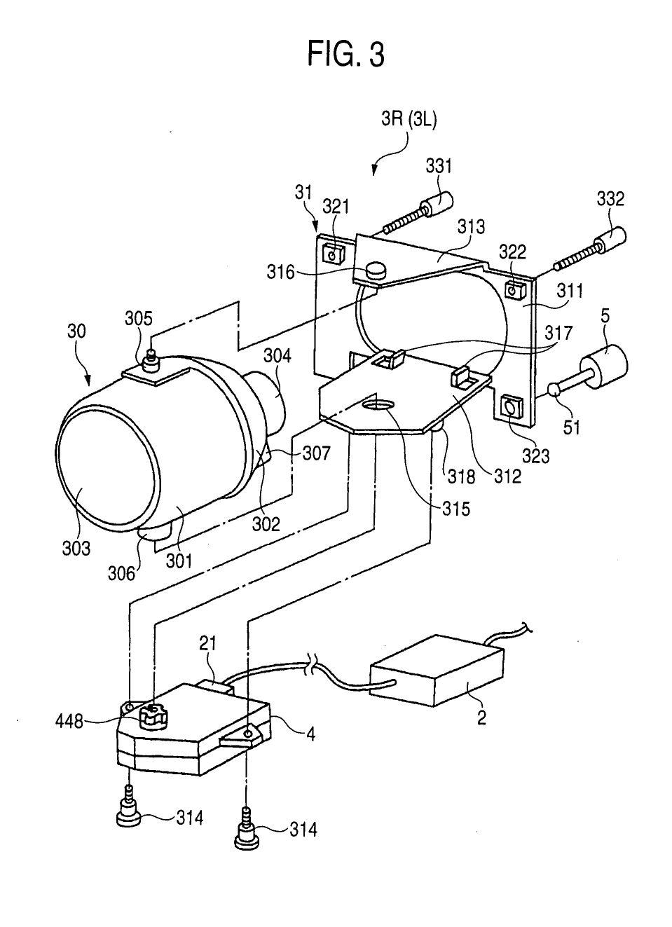

Next, referring to the drawings, an embodiment of the present invention will be explained below. FIG. 2 is a longitudinal sectional view showing an internal structure of the head lamp 3 composed of the swivel lamps 3R, 3L, the irradiating directions of which can be deflected to the right and left, in the components of AFS which are a lamp deflection angle control means of the present invention shown in FIG. 1. FIG. 3 is a partially exploded perspective view showing the primary portion. The lens 12 is attached to a front opening of the head lamp device body 11, and the rear cover 13 is attached to a rear opening of the head lamp device body 11 so that the lighting chamber 14 is formed. In this lighting chamber 14, there is provided a projector lamp 30. In the projector lamp 30, the sleeve 301, the reflector 302, the lens 303 and the light source 304 are integrated into one body. Since this the projector lamp 30 has been used widely, the detailed explanations are omitted here. In this embodiment, the light source 304 is composed of an electric discharge bulb. The projector lamp 30 is supported by an approximately C-shaped bracket 31. In the periphery of the projector lamp 30 in the head lamp device body 11, there is provided an extension so that the inside can not be exposed through the lens 12. Further, in this embodiment, the lighting circuit 7 for lighting the electric discharge bulb 304 of the projector lamp 30 is built in the lower cover 16 attached to a bottom face opening of the head lamp device body 11.

The projector lamp 30 is supported between the lower plate 312 and the upper plate 313, which are respectively formed being bent while making a right angle with the vertical plate 311 of the bracket 31. On the lower side of the lower plate 312, the actuator 4 described later is fixed by the screw 314. The rotary output shaft 448 of the actuator 4 is protruded upward through the shaft hole 315 formed on the lower plate 312. The screw 314 is screwed to the boss 318 protruding to a lower face of the lower plate 312. The shaft 305 provided on an upper face of the projector lamp 30 is engaged with the bearing 316 provided on the upper plate 313. The connecting section 306 provided on a lower face of the projector lamp 30 is engaged and connected with the rotary output shaft 448 of the actuator 4. Due to the above structure, the projector lamp 30 can be rotated to the right and left with respect to the bracket 31. Further, the projector lamp 30 can make a rotary motion in the horizontal direction integrally with the rotary output shaft 448 driven by the actuator 4.

When the bracket 31 is viewed from the front face side, the aiming nuts 321, 322 are respectively integrally attached to the right and the left upper portion of the bracket 31. The leveling bearing 323 is integrally attached to the right lower portion. The aiming nuts 312, 322 are respectively screwed to the horizontal aiming screw 331 and the vertical aiming screw 332 which are pivotally supported by the head lamp device body 11. The leveling bearing 323 is engaged with the leveling ball 51 of the leveling mechanism 5 supported by the head lamp device body 11. Due to the above structure, when the horizontal aiming screw 331 is rotated, the bracket 31 can be horizontally rotated round a straight line connecting the aiming nut 322 on right with the leveling bearing 323. When the horizontal aiming screw 331 and the vertical aiming screw 332 are simultaneously rotated, the bracket 31 can be rotated in the upward and downward direction round the leveling bearing 323. Further, when the leveling mechanism 5 is operated, the leveling ball 51 is moved in the axial direction, and the bracket 31 can be rotated in the upward and downward direction round a straight line connecting the aiming nut 312 with the aiming nut 322. Due to the foregoing, it becomes possible to conduct an aiming adjustment for adjusting the optical axis of the projector lamp 30 to the right and left and in the upward and downward direction. It also becomes possible to conduct an aiming adjustment for adjusting the optical axis of the projector lamp 30 in the upward and downward direction according to the leveling state when the level of an automobile is changed. In this connection, the protrusion 307 protrudes from a lower face of the reflector 302 of the projector lamp 30. On the lower plate 312 of the bracket 31 opposing to the protrusion 307, there are provided a pair of stoppers 317 which are arranged on the right and left. When the projector lamp 30 is rotated, the protrusion 307 collides with one of the stoppers 317, so that the rotary range of the projector 30 can be regulated.

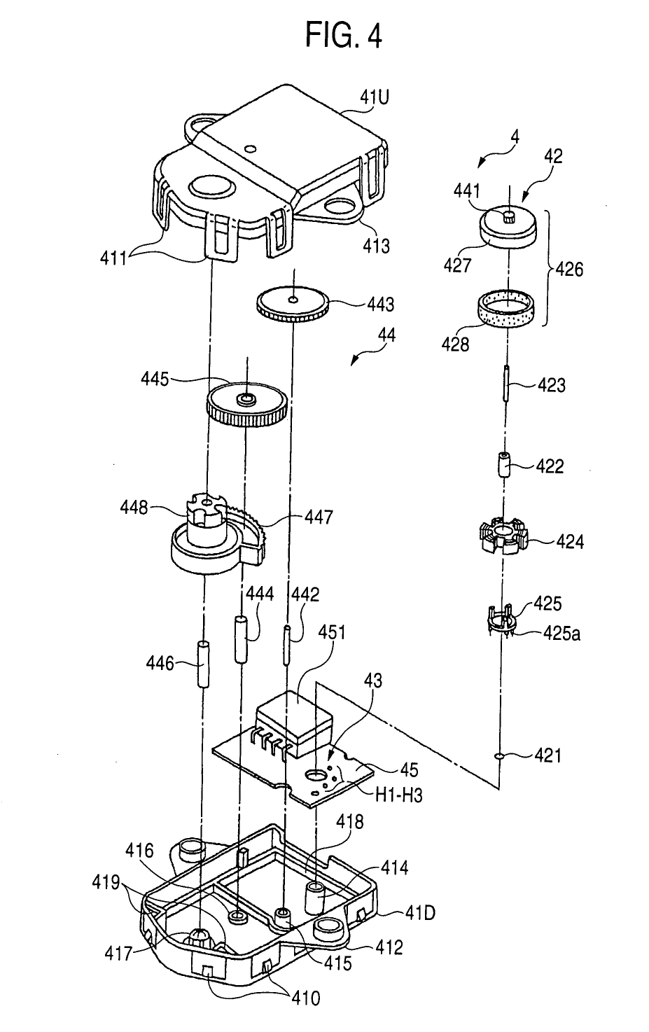

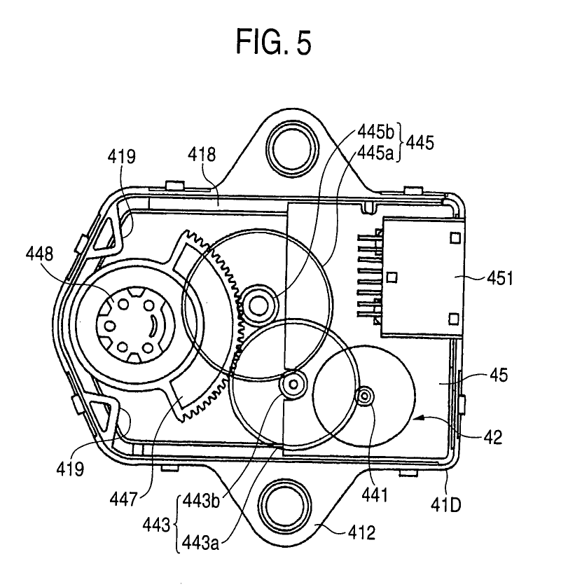

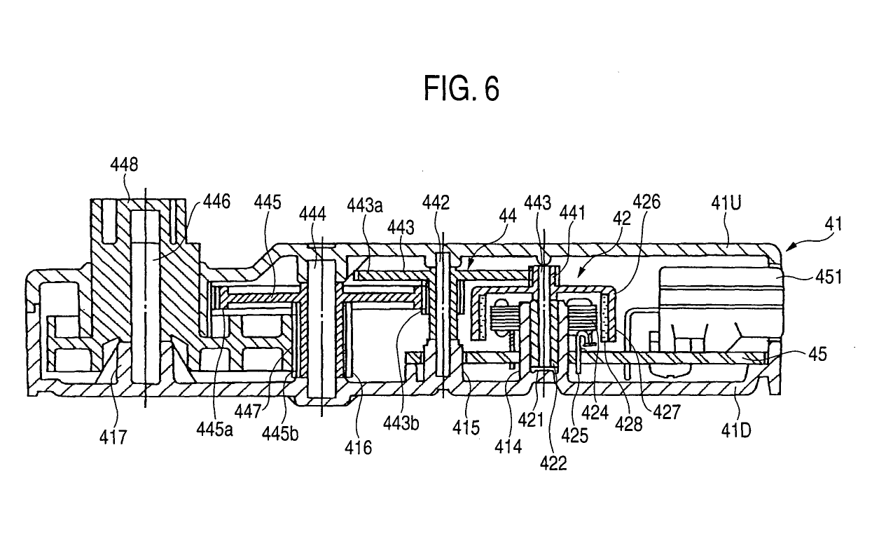

FIG. 4 is an exploded perspective view of a primary portion of the actuator 4 for swiveling the swivel lamp 3R, 3L, FIG. 5 is a plan view showing an assembling structure, and FIG. 6 is a longitudinal sectional view. The case 41 is composed of a lower half 41D and an upper half 41U which are respectively formed into a substantially pentagonal dish-shaped profile. When a plurality of protrusions 410 protruding from the circumferential face of the lower half 41D and a plurality of engaging pieces 411 hanging downward from the circumferential face of the upper half 41U are engaged with each other so that a case chamber can be formed inside. On both sides of the upper half 41U and the lower half 41D, the support pieces 412, 413 are respectively protruded toward both sides. These support pieces 412, 413 are used when the case 41 is fixed in such a manner that the screw 314 is screwed to the boss 318 of the bracket 31 as described above. The rotary output shaft 448 having a spline structure is protruded from the upper face of the case 41 and engaged with the connecting section 306 on the bottom face of the projector lamp 30. On the back face of the case 41, there is provided a connector 451 with which the external connector 21 (shown in FIG. 2) connected with ECU 2 is engaged.

On the inner bottom face of the lower half 41D of the case 41, there are vertically provided four hollow bosses 414, 415, 416, 417. To the first hollow boss 414, the brushless motor 42 described later, which is a drive motor, is assembled. To the second to the fourth boss 415, 416, 417, the shafts of the gear mechanism 44 described later are inserted so that the gear mechanism 44 can be supported. Along the periphery of the inner bottom face of the lower half 41D, there is integrally provided a step-like rib 418. The printed board 45 is put on this step-like rib 418 while a peripheral edge portion of the printed board 45 is coming into contact with the step-like rib 418. Therefore, the printed board 45 is set and supported inside the case 41 while the printed board 45 is being interposed between a rib, which is directed downward being provided in the upper half 41U not shown in the drawing, and the step-like rib 418. The first hollow boss 414 penetrates the printed board 45, and the brushless motor 42 to be assembled is electrically connected with the printed board 45. Various electronic parts not shown in the drawing, which compose the control circuit 43 described later, and the connector 451 are mounted on the printed board 45.

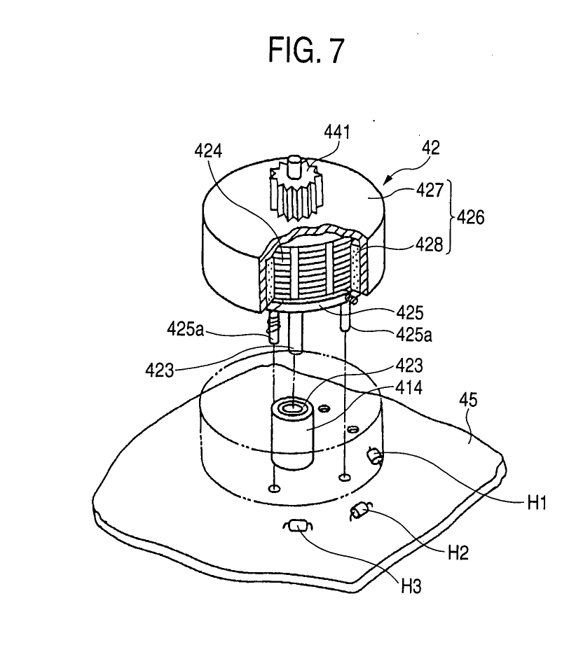

As shown in FIG. 7 which is a partially cutaway perspective view, the brushless motor 42 is arranged so that the rotary shaft 423 can be pivotally supported by the thrust bearing 421 and the sleeve bearing 422 in the first hollow boss 414 of the lower half 41D. The stator coil 424 including three pairs of coils, which are equally arranged in the circumferential direction, is fixed and supported by the first hollow boss 414. This stator coil 424 is electrically connected with the printed board 45 so that the stator coil 424 can be supplied with electricity. In this structure, the stator coil 424 is assembled integrally with the core base 425. By utilizing the terminal 425a provided on the core base 425, the printed board 45 is electrically connected. To an upper end portion of the rotary shaft 423, the cylindrical rotor 426 is attached in such a manner that the cylindrical rotor 426 covers the stator coil 424. The rotor 426 is composed of a cylindrical yoke 427, which is made of resin by means of molding, and an annular rotor magnet 428 which is attached on the inner circumferential face of the yoke 427, wherein the S-pole and the N-pole are alternatively arranged in the circumferential direction.

In the brushless motor 42 composed as described above, when an alternating electric current of the phases U, V and W, the phases of which are different from each other, is supplied to the three coils of the stator coil 424, a direction of the magnetic force generated between the stator coil 424 and the rotor magnet 428 is changed. Due to the foregoing, the rotor 426 and the rotary shaft 423 are rotated. Further, as shown in FIG. 7, on the printed board 45, there are provided a plurality of Hall elements H1, H2, H3 which are arranged in the circumferential direction of the rotor 426 at predetermined intervals. In this case, there are provided three Hall elements H1, H2, H3. When the rotor magnet 428 is rotated together with the rotor 426, the magnetic field at each Hall element H1, H2, H3 is changed being turned on and off. Therefore, each Hall element H1, H2, H3 is changed, and a pulse signal corresponding to the rotation period of the rotor 426 can be outputted.

The first gear 441 is molded by resin integrally with the yoke 427 of the rotor 426. This first gear 441 is composed as a portion of the gear mechanism 44. By this first gear 441, the rotary output shaft 448 is driven at a reduced gear ratio. In addition to the first gear 441 described above, the gear mechanism 44 includes: a second gear 443 pivotally supported by the first fixed shaft 442 supported by the second hollow boss 415; a third gear 445 pivotally supported by the second fixed shaft 444 supported by the third hollow boss 416; and a sector gear 447 formed integrally with the rotary output shaft 448 pivotally supported by the third fixed shaft 446 supported by the fourth hollow boss 417. These gears are respectively made of resin by means of molding. As shown in FIGS. 5 and 6, the second gear 443 is composed of a second large diameter gear 443a and a second small diameter gear 443b which are integrated into one body in the axial direction. The second large diameter gear 443a is meshed with the first gear 441. The third gear 445 is composed of a third large diameter gear 445a and a third small diameter gear 445b which are integrated into one body in the axial direction. The third large diameter gear 445a is meshed with the second small diameter gear 443b. Further, the third small diameter gear 445b is meshed with the sector gear 447. Due to the above structure, torque of the first gear 441 rotated integrally with the rotor 427 of the brushless motor 42 is transmitted to the rotary output shaft 448 via the second gear 443, the third gear 445 and the sector gear 447 while the rotary speed is being reduced by those gears. On the inner face of the lower half 41D on both sides of the rotary direction of the sector gear 447, there are provided stoppers 419, which are protruding, colliding with the end portions of the sector gear 447 concerned. The entire rotary angle range of the sector gear 447, in other words, the entire rotary angle range of the rotary output shaft 448 can be restricted by these stoppers 419.

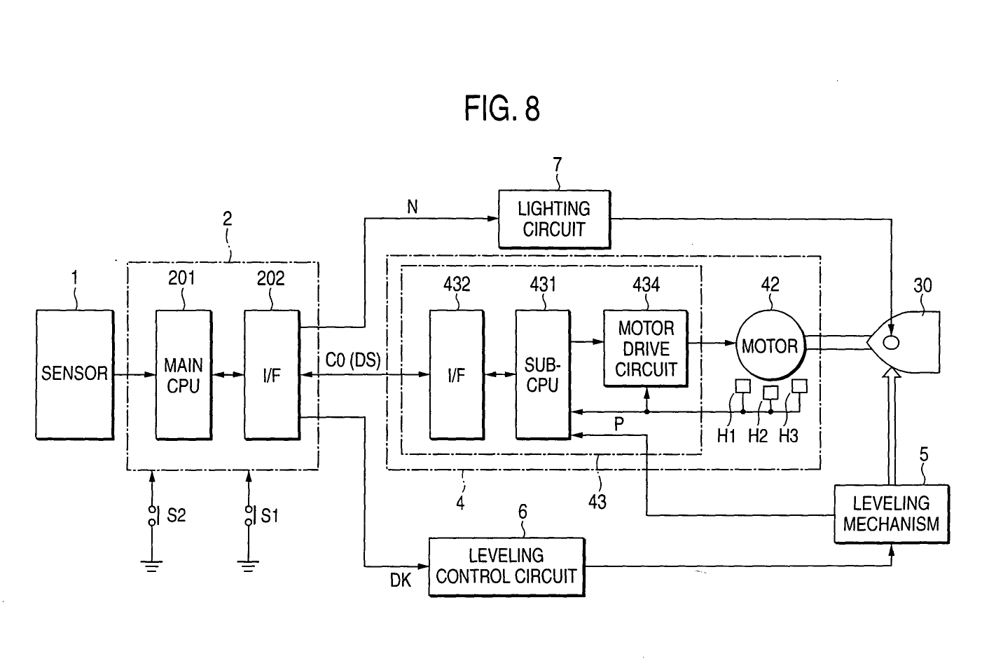

FIG. 8 is a block circuit diagram showing an electric circuit structure of the illuminating device including ECU 2 and the actuator 4 described before. In this connection, the actuator 4 is provided in each of the right 3R and the left swivel lamp 3L and capable of conducting a bidirectional communication with ECU 2. ECU 2 includes: a main CPU 201 in which a predetermined algorithm is conducted according to information sent from the sensor 1 so as to output a required control signal C0; and an interface (referred to as I/F hereinafter) circuit 202 for inputting and outputting the control signal C0 between the main CPU 201 and the actuator 4. A signal of ON and OFF of the illumination switch S1 provided in an automobile can be inputted into the above ECU 2. According to ON and OFF of the illumination switch S1, the lighting circuit 7 for supplying electric power to the electric discharge bulb 304 of the projector lamp 30 is controlled by the control signal N, so that both the swivel lamps 3R, 3L can be turned on and off. ECU 2 controls the leveling control circuit 6 for controlling the leveling mechanism 5, which is used for adjusting the optical axis of the bracket 31 to support the projector lamp 30, in the upward and downward direction by the leveling signal DK, so that the optical axis of the projector lamp 30 can be adjusted according to a change in the level of an automobile. In this connection, of course, an electric connection of the above electric circuit with the electric power supply is turned on and off by the ignition switch S2 which is provided so that an electric system arranged in the automobile can be turned on and off.

The control circuit 43 provided on the printed board 45 built in the actuator 4, which is arranged in each of the right 3R and the left swivel lamp 3L of an automobile, includes: an I/F circuit 432 for inputting and outputting a signal to and from the ECU 2; a sub-CPU 431 for conducting a predetermined algorithm according to the signal inputted from the I/F circuit 432 and according to the pulse signal P outputted from the Hall elements H1, H2 and H3; and a motor drive circuit 434 for driving the brushless motor 42 which is a rotation drive means. In this case, the right and left deflection angle signals DS of the swivel lamps 3R, 3L, which are a portion of the control signal C0, are outputted from ECU 2 and inputted into the actuators 4.

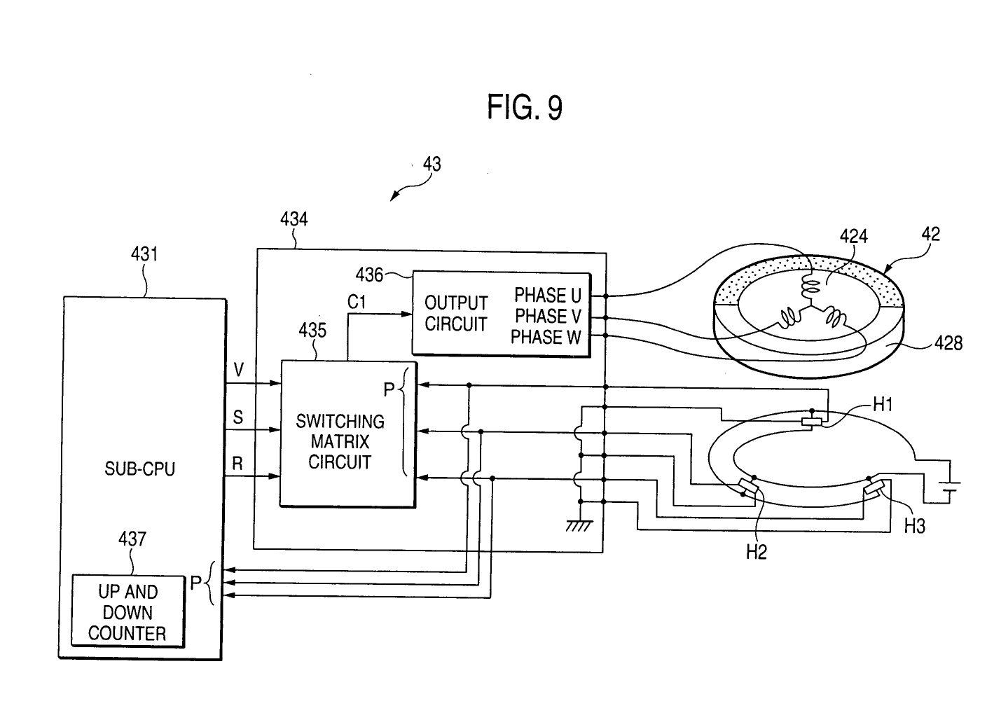

FIG. 9 is a schematic circuit diagram showing the motor drive circuit 434 of the control circuit 43 in the actuator 4 and also showing the brushless motor 42. The motor drive circuit 434 includes: a switching matrix circuit 434 into which the speed control signal V, the start and stop signal S and the normal and reverse rotation signal R, which are control signals sent from the sub-CPU 431 of the control circuit 43, are respectively inputted and further the pulse signals sent from the three Hall elements H1, H2 and H3 are inputted; and an output circuit 436 for adjusting the phases (phase U, phase V and phase W) of three phase electric power to be supplied to the three pairs of coils of the stator coil 424 of the brushless motor 42 when an output of this switching matrix circuit 435 is received. In this motor drive circuit 434, when electric power, the phases of which are phase U, phase V and phase W, is supplied to the stator coil 424, the magnet roller 428 is rotated, and the yoke 427 integrated with the magnet roller 428, that is, the rotor 426 and the rotary shaft 423 are rotated. When the magnet rotor 428 is rotated, the Hall elements H1, H2 and H3 detect a change in the magnetic field and output a pulse signal P. This pulse signal P is inputted into the switching matrix circuit 435. In the switching matrix circuit 435, switching operation of the output circuit 436 is conducted in the time relation with the pulse signal. Due to the foregoing, the rotation of the rotor 426 is continued.

The switching matrix circuit 435 outputs a required control signal C1 to the output circuit 436 according to the speed control signal V, the start and stop signal S and normal and reverse rotation signal R sent from the sub-CPU 431. The output circuit 436 receives this control signal C1 and adjusts the phases of the three phase electric power supplied to the stator coil 424, so that the start, stop, rotary direction and rotary speed of the rotation of the brushless motor 42 are controlled. Into the sub-CPU 431, a portion of the pulse signal P outputted from each of the Hall elements H1, H2 and H3 is inputted, so that a state of the rotation of the brushless motor 42 can be recognized. In this case, the up and down counter 437 is built in the sub-CPU 431. Therefore, when the pulse signals sent from the Hall elements H1, H2 and H3 are counted, the counted values are made to correspond to the rotary position of the brushless motor 42.

According to the above constitution, operation is conducted as follows. When ignition switch S2 is turned on and illumination switch S1 is turned, pieces of information such as a steering wheel angle of steering wheel SW, a running speed of the automobile and a level of the automobile are inputted into ECU 2 from the sensor 1 arranged in the automobile as shown in FIG. 1. According to the output of the sensor which has been inputted into ECU 2, the main CPU 201 conducts calculation, and the right and left deflection angle signal DS of the projector lamp 30 of the swivel lamp 3R, 3L of the automobile is calculated and inputted into the actuator 4 of each swivel lamp 3R, 3L. In the actuator 4, the sub-CPU 431 conducts calculation according to the right and left deflection angle signal DS thus inputted, and a signal corresponding to the right and left deflection angle signal DS is calculated and outputted into the motor drive circuit 434, so that the brushless motor 42 is driven. Since the rotation of the brushless motor 42 is reduced by the gear mechanism 44 and transmitted to the rotation output shaft 448, the projector lamp 30 connected with the rotation output shaft 448 is rotated in the horizontal direction, and the direction of the optical axis of the swivel lamp 3R, 3L is defected to the right and left. In this rotary motion of the projector lamp 30, a deflection angle of the projector lamp 30 is detected by the rotary angle of the brushless motor 42. That is, the sub-CPU 431 detects the deflection angle according to at least one of the pulse signals P (P1, P2, P3) outputted from the three Hall elements H1, H2, H3 provided in the brushless motor 42 as shown in FIG. 8. Further, the sub-CPU 431 compares the detection signal of the detected deflection angle with the right and left defection angle signal DS inputted from ECU 2 and conducts feedback control on the rotary angle of the brushless motor 42 so that both can agree with each other. In this way, the direction of the optical axis of the projector 30, that is, the direction of the optical axis of the swivel lamp 3R, 3L can be highly accurately controlled so that it can be at a deflection position that is set by the right and left deflection angle signal DS.

Due to the deflecting motion of the projector lamp 30 described above, deflected light, which is emergent from both swivel lamps 3R, 3L, illuminates right and left regions that are deflected from the direction in which the automobile is going straight. Therefore, while the automobile is running, it is possible for the projector lamps 30 to illuminate not only a region located in the direction in which the automobile is going straight but also a region located in the direction in which the steering operation is conducted. Accordingly, the safety of driving can be enhanced.

In this AFS, when at least one of the pulse signals P of the Hall elements H1, H2, H3 arranged corresponding to the brushless motor 42 is counted by the up and down counter 437, the rotary angle of the brushless motor 42 can be detected, and a deflection angle of the swivel reflector 15 deflected by the actuator 4, the drive source of which is the brushless motor 42, is correlatively detected. However, when trouble is developed in the transmission route of rotation from the brushless motor 42 to the projector lamp 30, the correlation between the pulse signal P and the deflection angle of the projector lamp 30 is damaged, and it becomes impossible to conduct a normal deflection control of the swivel lamp 3R, 3L.

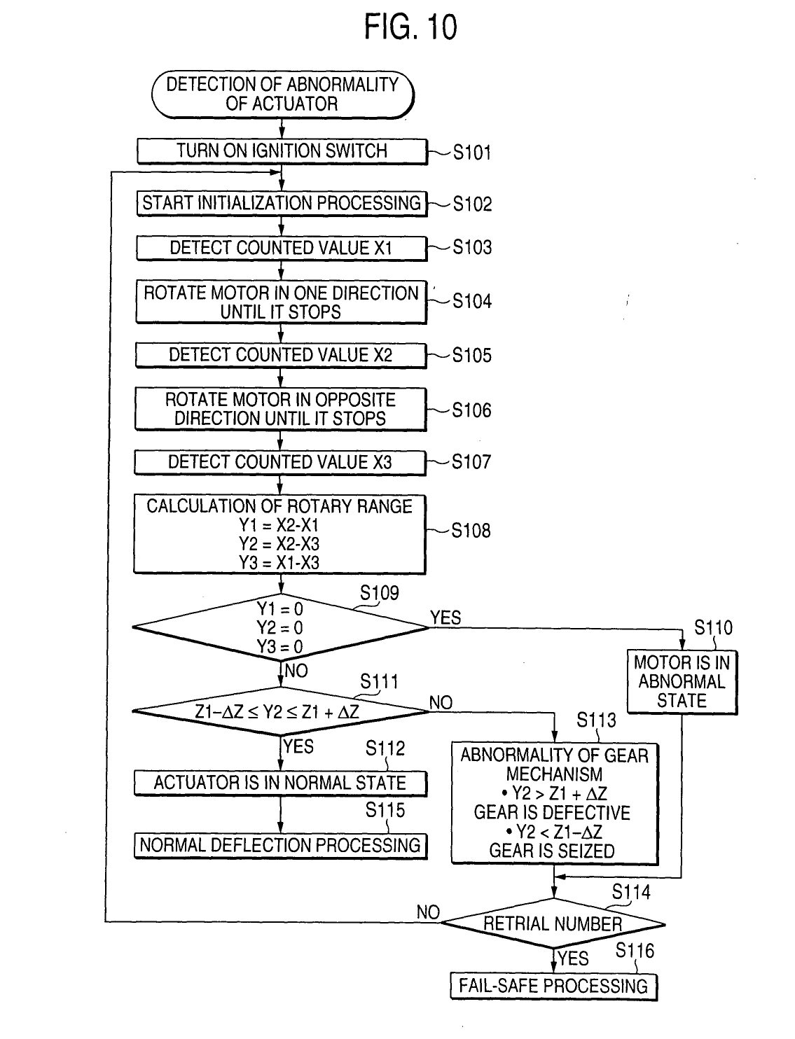

Therefore, in the present invention, a flow of detection is conducted to detect the occurrence of trouble in the actuator in the case where the ignition switch S2 is turned on. FIG. 10 is a flow chart to explain a flow of detection for detecting the occurrence of trouble of the actuator 4 when the ignition switch is turned on. When the ignition switch S2 is turned on (S101), initialization is executed so that the optical axis of irradiation of the swivel lamp 3R, 31 can be directed in a predetermined direction (S102). Usually, this initialization S102 is conducted to control and rotate the brushless motor 42 so that the projector lamp 30 of the swivel lamp 3R, 3L can be directed in the direction in which the automobile is going straight. In this case, as a portion of this initialization, the following process is executed here. First, counted value X1 of the up and down counter 437 at the time of initialization is detected (S103). Next, the sub-CPU 431 controls the brushless motor 42 by the motor drive circuit 434 so that the brushless motor 42 can be continuously driven on one direction (S104). When the rotation of the brushless motor 42 is stopped in the case of rotating in one direction, that is, when the protrusion 307 of the projector lamp 30 collides with one of the stoppers 317 of the bracket 31 and deflects to the maximum angle on one side or when the sector gear 447 collides with one of the stoppers 419, the counted value X2 is detected (S105). Next, the brushless motor 42 is continuously rotated in the opposite direction (S106). When the rotation of the brushless motor 42 is stopped, that is, when the protrusion 307 of the projector lamp 30 collides with the other stopper 317 and deflects to the maximum angle on the opposite side or when the sector gear 447 collides with the stopper 419 on the opposite side, the counted value X3 is detected (S107). In this case, since the apparatus is designed in such a manner that a rotary range of the brush motor 42 from the start of rotation to the collision of the sector gear 447 with the stopper 419 is larger than a rotary range of the brushless motor 42 of the collision of the protrusion 307 with the stopper 317, the counted value of the maximum angle is usually detected by the latter collision. The former rotary range regulation is prepared for the object of preventing an excessively large rotation of the projector lamp 30 in the case where the stopper function of the latter rotary range regulation is damaged.

With these counted values X1, X2 and X3, the following rotation range values Y1, Y2 and Y3 are calculated (S108).

Y1=X2−X1

Y2=X2−X3

Y3=X1−X3

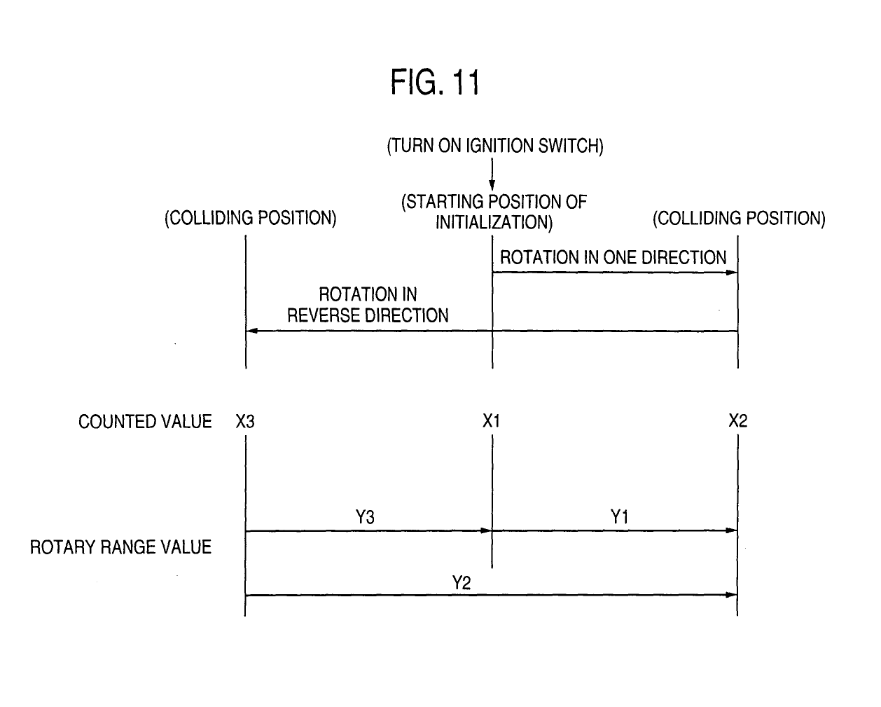

In this connection, FIG. 11 is a schematic illustration for explaining the above counted values X1, X2 and X3 and the rotary range values Y1, Y2 and Y3. In this case, the up and down counter 437 is set so that the counted value of the pulse signal is increased in the positive direction when the brushless motor 42 is rotated in one direction.

After that, according to the rotary range values Y1, Y2 and Y3, it is judged whether the brushless motor 42 of the actuator 4 and the gear mechanism 44 are in an abnormal state or not. In this judgment, first, it is judged whether or not Y1=0, Y2=0 and Y3=0 (S109). When all these conditions are satisfied, the rotary angle of the brushless motor 42 is 0, which means that the brushless motor 42 is locked and not rotated at all. In this case, it is judged that the brushless motor 42 is out of order and in an abnormal state (S110).

When it is judged in step S109 that the brushless motor 42 is in a normal state, the rotary range value Y2 corresponding to all deflection angle range of the projector lamp 30 is compared with the predetermined setting rotary range value Z1, which is obtained when the pulse signals are counted when the projector lamp 30 is normally deflected at the maximum angle of the projector 30 from one side to the opposite side, and it is judged whether or not Y2 is in the predetermined error range ΔZ of the setting rotary range value Z1 (S111). When Y2 is in the predetermined error range ΔZ, that is, when

Z1−ΔZ≦Y2≦Z1+ΔZ,

it is judged that the actuator 4 is in a normal state (S112).

On the other hand, when the rotary range value Y2 is not in the predetermined error range ΔZ of the setting rotary range value Z1 but the rotary range value Y2 is out of the range, it is judged that the gear mechanism 44 is in an abnormal state (S13). In this case, when the rotary range value Y2 is larger than the error range ΔZ, that is, when

Y2>Z1+ΔZ,

the rotary range of the brushless motor 42 is large although the projector lamp 30 has been defected in the maximum range, which means that the brushless motor 42 has excessively rotated. In this case, it is estimated that some of the gears 441, 443, 445 and 447 composing the gear mechanism 44 are damaged and running idle.

On the contrary, when the rotary range value Y2 is out of the predetermined error range ΔZ of the setting rotary range value Z1 and smaller than this error range ΔZ, that is, when

Y2<Z1−ΔZ,

it is estimated that the following problems are encountered. Although the projector lamp 30 is deflected by the rotation of the brushless motor 42, for example, some of the gears 441, 443, 445 and 447 of the gear mechanism 44 are locked being seized, so that the gear mechanism 44 can not be smoothly rotated. For the above reasons, the brushless motor 42 can not be rotated by the angle corresponding to all deflection range of the projector lamp 30.

As described above, in step S113 in which an abnormality of the gear mechanism 44 is detected, it is possible to specify a reason of the abnormality of the gear mechanism 44 by the rotary range value Y2. In this connection, in the case where it is judged in respective steps S110 and S113 that the brushless motor 42 or the gear mechanism 44 is in an abnormal state, in order to make confirmation, the program may return to step S102 and the process after the process of finding the rotary range values Y1, Y2 and Y3 may be repeated by a predetermined number of times. That is, after step S110 or S113, it is judged whether or not it has reached the number of retrial (S114). In the case where it has not reached the number of retrial, the program returns to step S102. In the case where it has reached the number of retrial, the retrial is completed and the occurrence of an abnormality is decided.

When it is judged in step S112 that the actuator 4 is in a normal state, a signal representing that the actuator 4 is in the normal state is sent from the sub-CPU 431 of each actuator to ECU 2, and the main CPU 201 of ECU 2 receives the signal representing that the actuator 4 is in the normal state, and usual processing of deflection is executed (S115). When it is judged to be abnormal even after the retrial has been conducted, a signal representing the occurrence of an abnormality is sent to ECU 2 from the sub-CPU 431 of each actuator 4, and the main CPU 201 of ECU 2 receives the signal representing the occurrence of an abnormality and executes fail-safe processing (S116). This fail-safe processing is conducted in such a manner that, for example, when the projector lamp 30 can be deflected, the projector lamp 30 concerned is deflected and fixed to the maximum deflection angle on the left. This direction of the left is opposite to the opposed lane in Japan where they drive on the left. Therefore, a driver driving an automobile in the opposed lane is not dazzled by the light emitted by the swivel lamps 3R, 3L. In this connection, in Europe and America where they drive on the right, the swivel lamps 3R, 3L are deflected to the maximum deflection angle to the right and then rotated to the left by a predetermined angle so that the swivel lamps 3R, 3L can be set at the reference positions. In the case where the projector lamp 30 can be deflected in the same way, the projector lamp 30 may be stopped at a position where it is directed in the direction in which the automobile is going straight.

In the case where the projector lamp 30 can not be deflected in the fail-safe processing, ECU 2 controls the lighting circuit 7 so as to turn off the supply of electric power to the swivel lamps 3R, 3L. Alternatively, a low intensity of electric current is made to flow in each swivel lamp 3R, 3L so as to emit light at a low luminance. Due to the foregoing, even when the projector lamp 30 is deflected in the direction in which a driver driving an automobile running in the opposed lane is dazzled by the headlight, it is possible to prevent the driver from being dazzled. In this connection, only the supply of electric power to a swivel lamp 3R, 3L, which is in an abnormal state, may be stopped, and the supply of electric power to a swivel lamp 3R, 3L, which is in a normal state, may be conducted in the same way as that of the normal state, and the same deflection control as that of the normal state may be conducted.

As described above, in the present invention, AFS can be properly controlled according to the pulse signals P sent from the Hall elements H1, H2 and H3. Further, the occurrence of an abnormality of the brushless motor 42 or the gear mechanism 44 can be specifically judged according to the pulse signals P concerned. Therefore, in the occurrence of an abnormality of AFS, the fail-safe control can be realized and the safety of traffic can be ensured. On the other hand, it becomes possible to execute an appropriate maintenance work. Further, AFS can be properly controlled.

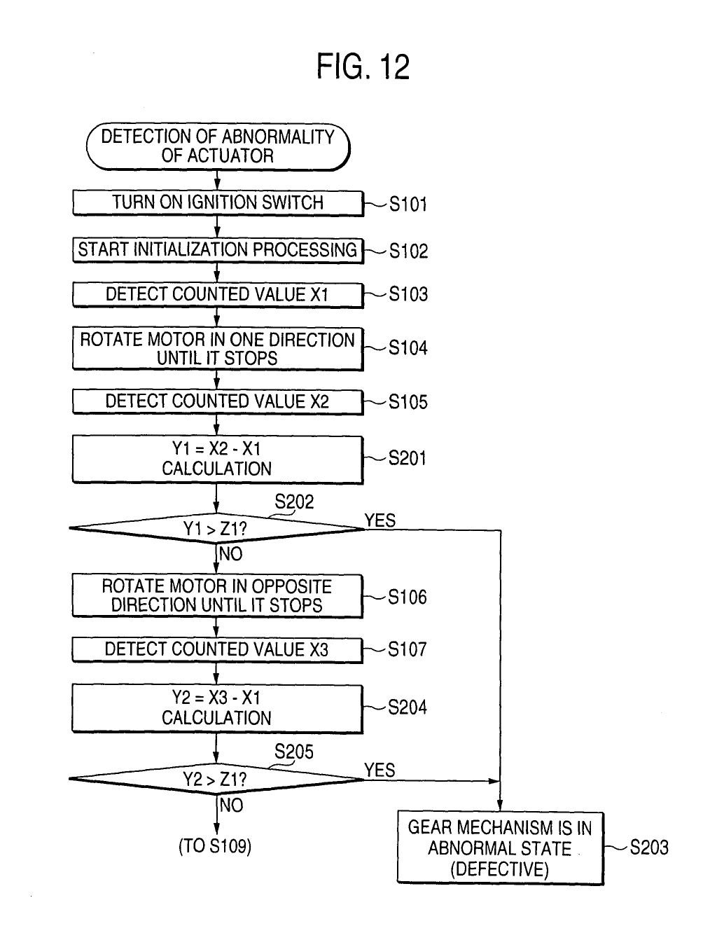

In this connection, in the present invention, when the gear mechanism 44 is damaged, it can be considered that the rotary range value Y1 in the case of rotating the brushless motor 42 in one direction exceeds the predetermined setting rotation range value Z1. Accordingly, as shown in the flow chart of FIG. 12, immediately after the counted value X2 is detected in step S105, the rotary range value Y1 is calculated (S201), and this rotary range value Y1 is compared with the setting rotary range value Z1 (S202). When Y1>Z1, it is immediately judged whether or not the gear mechanism 44 is in an abnormal state (S203). In the same manner, from the counted value X3 obtained when the brushless motor 42 is operated in the opposite direction, the rotary range value Y2 is immediately calculated (S204), and this rotary range value Y2 is compared with the setting rotary range value Z1 (S205). When Y2>Z1, it is immediately judged that the gear mechanism 44 is in an abnormal state (S203). In this case, in the same manner as that of the embodiment described before, of course, the error ΔZ may be considered with respect to the setting rotary range value Z1. In this embodiment, one direction described before is not specified. Of course, one direction and the other direction may be reverse. When this flow is adopted, it is possible to quickly judge the occurrence of an abnormality of the gear mechanism 44.

In this case, counting of the pulse signals by the up and down counter 437 of the sub-CPU 431 may be conducted on any pulse signals P1, P2 and P3 of the Hall elements H1, H2 and H3. In the case where a period of the pulse signal sent from the Hall element is very short, counting may be conducted after the pulse signal has been divided.

In the above embodiment, the present invention is applied to a head lamp device in which the projector lamp composing the swivel lamp is deflected to the right and left so as to change the irradiating optical axis. However, it is possible to apply the present invention to a head lamp device in which only the reflector conducts a deflecting motion. Alternatively, it is possible to apply the present invention to a head lamp device in which the substantial irradiating range is changed by conducting a deflecting motion on the auxiliary reflector provided independently from the primary reflector.

As explained above, the head lamp device of the present invention includes: a rotation range detection means for detecting a rotation range of a drive motor of a rotation drive means for driving a light distribution control means for controlling a light distribution of the head lamp; and an abnormality judgment means for judging an abnormality of the rotation drive means according to a rotation range of the drive motor detected by the rotation range detection means when the rotation drive means is driven. Therefore, it is possible to judge the occurrence of an abnormality in the case where the drive motor of the rotation drive means and the gear mechanism develop trouble, and further it is possible to specifically judge a cause of the abnormality. Due to the foregoing, when AFS is in an abnormal state, it is possible to realize a fail-safe operation so that the safety of traffic can be ensured. On the other hand, it is possible to execute an appropriate maintenance work corresponding to the cause of an abnormality. Further, AFS can be properly controlled.

What is claimed is:

1. A vehicle head lamp apparatus comprising:
a light distribution control means for controlling an irradiation direction or an irradiation range of light sent from a light source;
a rotation drive means having a drive motor which drives the light distribution control means;
a rotation range detection means for detecting a rotation range of the drive motor; and an
abnormality judgment means for judging an abnormality of the rotation drive means according to a rotation range of the drive motor detected by the rotation range detection means when the rotation drive means is driven in a predetermined condition.

2. A vehicle head lamp apparatus according to claim 1, wherein the abnormality judgment means judges an abnormality under the predetermined condition by comparing a rotation range, which is obtained when the drive motor is rotated in one direction and then rotated in the opposite direction, with a predetermined rotation range.

3. A vehicle head lamp apparatus according to claim 1, wherein the abnormality judgment means judges an abnormality under the predetermined condition by comparing one of the rotation ranges, one range is obtained when the drive motor is rotated in one direction and the other rotation range is obtained when the drive motor is rotated in the opposite direction, with a predetermined rotation range which is previously set, and when the rotation range is larger than the predetermined rotation range which is previously set, the rotation is judged to be abnormal.

4. A vehicle head lamp apparatus according to claim 1, wherein the abnormal judgment means repeats a judgment motion when it has judged an abnormality.

5. A vehicle head lamp apparatus according to claim 1, wherein the rotation range detection means includes a sensing element which outputs pulse signals in response to the rotation of the drive motor, and an up-down counter which counts number of the pulses.

6. A vehicle head lamp apparatus according to claim 5, wherein the abnormality judgment means judges an abnormality by comparing a rotation range with a predetermined rotation range, the rotation range is obtained from a first counting number of the up-down counter when the drive motor is rotated in one direction and a second counting number of the up-down counter when rotated in the opposite direction.

7. A vehicle head lamp apparatus according to claim 1, wherein when it is judged as abnormal condition, the head lamp is deflected and fixed at a maximum deflection angle.

8. A vehicle head lamp apparatus according to claim 1, wherein when it is judged as abnormal condition, the head lamp is directed forward.

9. A vehicle head lamp apparatus according to claim 1, wherein when it is judged as abnormal condition, the head lamp emit light at a low luminance.
